(19) United States
(12) Patent Application Publication
(10) Pub. No.: US 2015/0143327 A1
(43) Pub. Date: May 21, 2015

(54) PROJECT MANAGEMENT TOOL

(71) Applicant: LinkedIn Corporation, Mountain View, CA (US)

(72) Inventors: Scott Holmes, Morgan Hill, CA (US); Manish Dubey, Fermont, CA (US); Sean Keenan, San Francisco, CA (US)

(73) Assignee: LinkedIn Corporation, Mountain View, CA (US)

(21) Appl. No.: 14/081,959

(22) Filed: Nov. 15, 2013

(51) Int. Cl. G06F 9/44

(52) U.S. Cl. CPC G06F 8/70
USPC 717/101

(57) ABSTRACT

An example project management tool, which is a computer-implemented system configured to provide a real-time view of a product change with respect to its status within a testing process, is provided. In operation, the project management tool receives a request to create a new project for a particular product change, determines the requirement definition included in the request and, based on the requirement definition, identifies all components of the associated computing application that are affected by the product change. The project management tool then uses the monitored information to generate one or more views that may provide users with information regarding the estimated time of arrival (ETA) of the product that has a certain product change incorporated into it.

### TECHNICAL FIELD

This application relates to the technical fields of software and/or hardware technology and, in one example embodiment, to a project management tool, which is a computer-implemented system configured to provide a real-time view of a product change with respect to its status within a testing process.

### BACKGROUND

In software development, it is not uncommon to make changes to source code of a computing application. The changes may be made in order to include a new or enhanced feature, to fix a bug, etc. A change to one component of a computer-implemented product—e.g., a change to a code module of a computing application—often affects other components of that product. A developer may not always know which and how many of the other components (e.g. services, libraries, etc.) may be affected by their change. This makes it unclear to the developer what is the estimated time of arrival (ETA) of the product that has the change incorporated into it.

A computer-implemented product may be, for example, an on-line social network, which is as a platform to connect people in virtual space. An on-line social network may be a web-based platform, such as, e.g., a social networking web site. An on-line social network may be accessed by a user via a web browser, via a mobile application, etc.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example project management tool may be implemented;

FIG. 2 is block diagram of a project management tool, in accordance with one example embodiment;

FIG. 3 is a flow chart of a method for utilizing a project management tool, in accordance with an example embodiment;

FIG. 4 is a view to present information regarding a status of a project associated with the product change, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A project management tool is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

In one embodiment, a project management tool may be used to provide a real-time view of a product change with respect to its status within a testing process. A product change, for the purposes of this description, will be understood as a change to one or more components of a computer-implemented product. A product change may be, e.g., a change to source code in a library. A computer-implemented product (also referred to as merely “product”) may also be referred to as a computing application. A computing application may be, e.g., a web service or a collection of web services. For example, an on-line social networking application may be designed and built as a collection of web services. For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members.

In software development, components of a computer-implemented product (e.g., source code, documentation, etc.) may undergo revisions, as new features are being added, bugs being fixed, etc. Once the developer who works on the particular component completes a change, e.g., a change to a source code module, the changed code can be transferred to a code repository. The process of transferring the changed code to a code repository may be termed a commitment process. A commitment process may start with a request to commit a code module to a code repository, after which preliminary tests with respect to the code module may be performed. Then, the code module is assigned a specific version/revision identification and stored in a source code repository that may be part of a code control and repository system. After a code module is committed to a source code repository, it can be incorporated into the product by a build process. The resulting product may be then released into a test environment and then, upon successful completion of testing, into a production environment.

As mentioned above, a change to one component of a computer-implemented product often affects other components of that product. For example, a computer-implemented product may include various services that, in turn, use various libraries of shared code. A collection of all components of a computing application that are affected by a particular product change and that therefore have to successfully complete a test cycle before the product change can be released into production may be referred to as a project. A project management tool may be configured to determine all components of a computing application that are affected by a particular product change based on a brief definition of a product change, obtain information regarding the status of each of the affected components in the testing cycle, and generate one or more views that permit users to follow progress of each of the affected components in the testing cycle.

The brief definition of a product change may be termed a project requirement. A project requirement, in one example embodiment, includes a description of the nature of the project, such as, e.g., “this project tracks fixing the security bug,” and a requirement definition. A requirement definition is a conditional expression and may be provided to the project management tool in various formats. For example, a requirement definition may include the identification of a library that includes the product change and the version of the library. In this example, a user would provide the version of the library that has changed, and the project management tool would compute and maintain the list of the components that depend on this library and, thus, require being built and deployed. Another format of the requirement definition is the revision number associated with the product change. A revision identifies a particular change to the source code, a particular check-in, as opposed to the version of a product. In this example, the project management tool computes and maintains a list components that depend on the specific code change referenced by the revision number and, thus, requires being built and deployed. Yet another format of the requirement definition may be the identification of a service, for which the change was made, and the version of the service. In this example, the service is identified by the user and the project management tool facilitates the tracking of the build and deployment of this particular service.

In order to obtain information regarding the status of each of the affected components, the project management tool may cooperate with a so-called change request tracker system. A change request tracker system tracks events that occur with respect to a code module from the time a developer requests to commit the code module to a code repository and up until the time when the code module is deployed as part of a computing application. A process that starts with a developer generating source code and ends with releasing the associated application to the public may be termed a development and testing pipeline or just a pipeline. A change request tracker may be configured to create, modify, monitor, and report events occurring in a pipeline. A pipeline may include stages such as, e.g., the build process, deployment in a testing environment, partial deployment in a production environment, and full deployment in a production environment. After a code module has been committed to the code repository, the change request tracker may monitor events associated with the pipeline, store the collected information, and make it available for viewing. The monitored information may include information such as the current status of the code module and the associated service, past events associated with the code module and the associated service, duration of testing of the code module and the associated service, duration of various events associated with the code module and the associated service, results of each stage of the pipeline, etc. A change request tracker may make this information available to the project management tool. The project management tool may utilize this information to generate one or more views that permit users to follow progress of the test cycle for components affected by a particular product change.

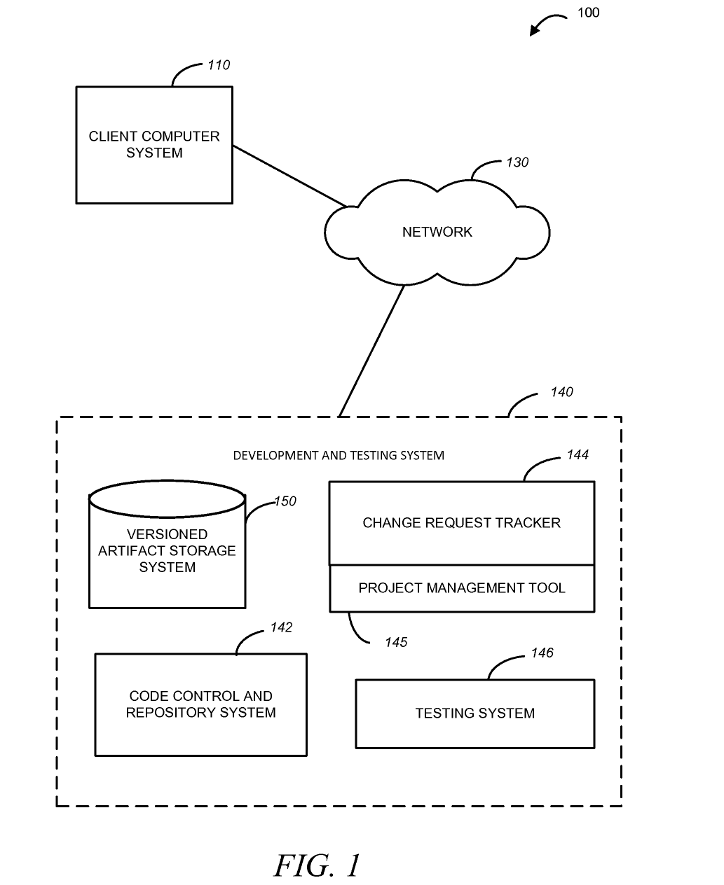

For example, the project management tool may generate a project progress view that lists one or more projects and the progress in the test cycle for each of the listed project. A project progress view also may include information identifying respective project owners and respective descriptions of the listed projects. A project owner is a person responsible for the completion of the testing cycle for a particular project. A project progress view may thus aid in providing users with information regarding the ETA of the product that has the product change incorporated into it. The project management tool may also be configured to generate spreadsheet-like view of all or for a subset of project components, which may be termed a detailed project view. The detailed project view may list all services, libraries, etc. in the project and may show, for each listed component of the project, the status of the respective service, library, etc. in the test cycle. For example, the detailed project view may indicate that a certain service has been built but not yet deployed into the testing environment, while another service has not yet been built into a version that includes the product change. The views that are generated by the project management tool based on a project requirement provided by a user may be updated dynamically and in in real time, as components of the project that is being reflected in the views proceeds through the test cycle. An example project management tool may be implemented in the context of a network environment 100 illustrated in FIG. 1.

As shown in FIG. 1, the network environment 100 may include a code control and repository system 142, a change request tracker 144, a project management tool 145, a testing system 146, and a versioned artifact storage system 150, which collectively may be referred to as a development and testing system 140. The code control and repository system 142 may be configured to permit version control of application code, storing of the application code, etc. The code control and repository system 142 may also include a dependencies database that stores mapping information between different versions of services and different versions of libraries that are used in a computing application. The change request tracker 144 may be configured to communicate with the code control and repository system 142 and also with the testing system 146. For instance, the change request tracker 144 may send to the code control and repository system 142 a trunk lock instruction, such that no further code changes are permitted to be committed into the code until the trunk lock is released. The change request tracker 144 may also communicate to the testing system 146 a request to execute a particular stage in the pipeline and may also obtain the testing system 146 results of the tests. Results of the build process are stored in the versioned artifact storage system 150 for use in later stages of the pipeline. A version of application code that has gone through the test and build pipeline successfully may be termed a versioned artifact and may be stored in a versioned artifact storage system. A versioned artifact may be deployed on a fabric. A fabric is a collection of computer systems in a data center that may be located remotely from the location of a server system hosting the change request tracker 144.

The change request tracker 144 may be configured to cooperate with a project management tool 145. The project management tool 145 may be integrated with the change request tracker 114 or it may be implemented as a stand-alone application. In one embodiment, information tracked by the change request tracker 144 and the project management tool 145 may be accessible by users (e.g., developers) from their client machines, such as, e.g., from a client computer system 110, via a communications network 130. The communications network 130 may be a public network (e.g., the Internet, a mobile communication network, or any other network capable of communicating digital data). The testing system 146 may be configured to generate, store, and execute test scripts, to monitor and process test results, etc.

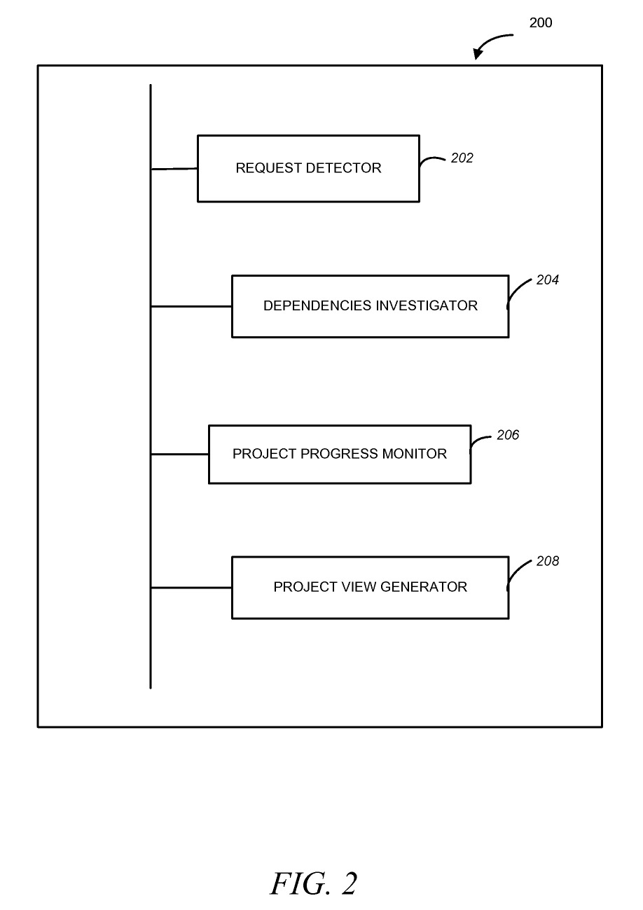

In operation, the project management tool 145 receives a request to create a new project for a particular product change, determines the requirement definition provided with the request and, based on the requirement definition, identifies all components of the associated computing application that are affected by the product change. For example, as mentioned above, a computer-implemented product that is an on-line social networking system may include hundreds of services. Each service may have a number of versions. Each service having a certain version may utilize a number of libraries, where each library may have one or more versions. Each version of a service or a library may also be associated with a particular revision. A database that stores mapping information between the different versions of services, the different versions of libraries, and different revisions may be referred to as a dependencies database, which may be part of the code control and repository system 142. The project management tool 145 uses the requirement definition to interrogate the dependencies database and obtain identification of all components of the associated computing application that are affected by the product change. The project management tool 145 then uses information obtained from the dependencies database and information obtained from the change request tracker 144 to generate one or more views that may provide users with information regarding the ETA of the product that has a certain product change incorporated into it. An example project management tool is illustrated in FIG. 2.

FIG. 2 is a block diagram of a project management tool system 200. As shown in FIG. 2, the system 200 includes a request detector 202, a dependencies investigator 204, a project progress monitor 206, and a progress view generator 208. The request detector 202 may be configured to receive a project management request comprising an identification of a product change, the product change associated with a computing application. As explained above, an identification of a product change, termed a project requirement may include a description of the nature of the project and a requirement definition. A requirement definition may be provided to the request detector 202, such as the identification and the version of a library, the revision number associated with the product change, and the identification and the version of a service. The dependencies investigator 204 may be configured to use the requirement definition to interrogate a dependencies database and determine one or more components that are affected by the product change. As mentioned above, the collection of components of a computing application that are affected by a particular product change may be termed a project. The project progress monitor 206 may be configured cooperate with the change request tracker 145 of FIG. 1 to monitor status of each of the components determined to be affected by the product change with respect to a testing cycle of the associated computing application.

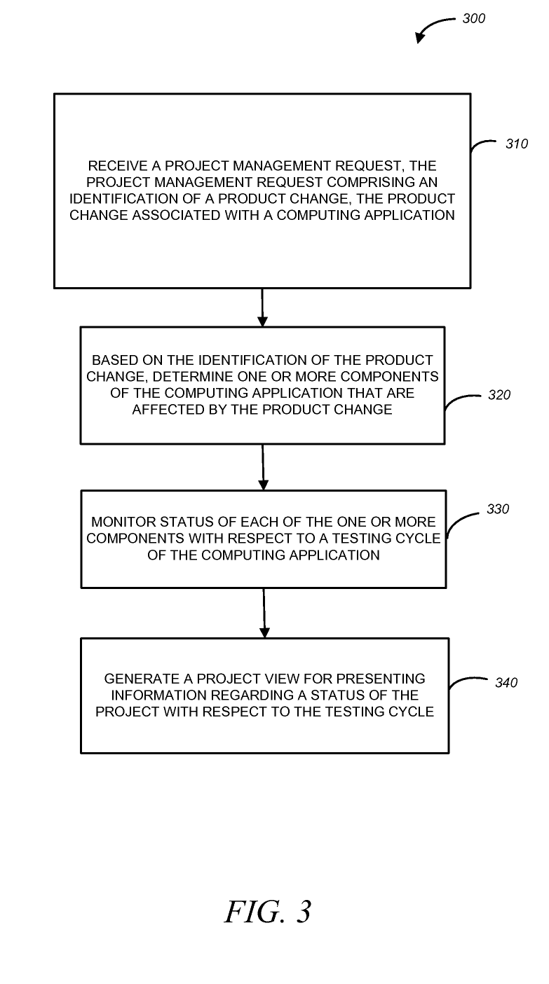

The progress view generator 208 may be configured to generate one or more project views for presenting information regarding a status of the project with respect to a testing cycle. As described above, the one or more project views may include a project progress view and a detailed project view. The project progress view may list multiple projects and, for each listed project, lists the progress of the project in the test cycle. The detailed project view may list all components affected by the product change in the project and may show, for each listed component, the status of the respective component in the test cycle. For example, as mentioned above, the detailed project view may indicate that a certain service has been built but not yet deployed into the testing environment, while another service has not yet been built into a version that includes the product change. The modules of the system 200 may be configured to provide various functionality described herein using at least one processor. Example operations performed by the system 200 may be described with reference to FIG. 3.

FIG. 3 is a flow chart of a method 300 for utilizing a project management tool system, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the development and testing system 140 of FIG. 1 and, specifically, at the project management tool system 200 shown in FIG. 2.

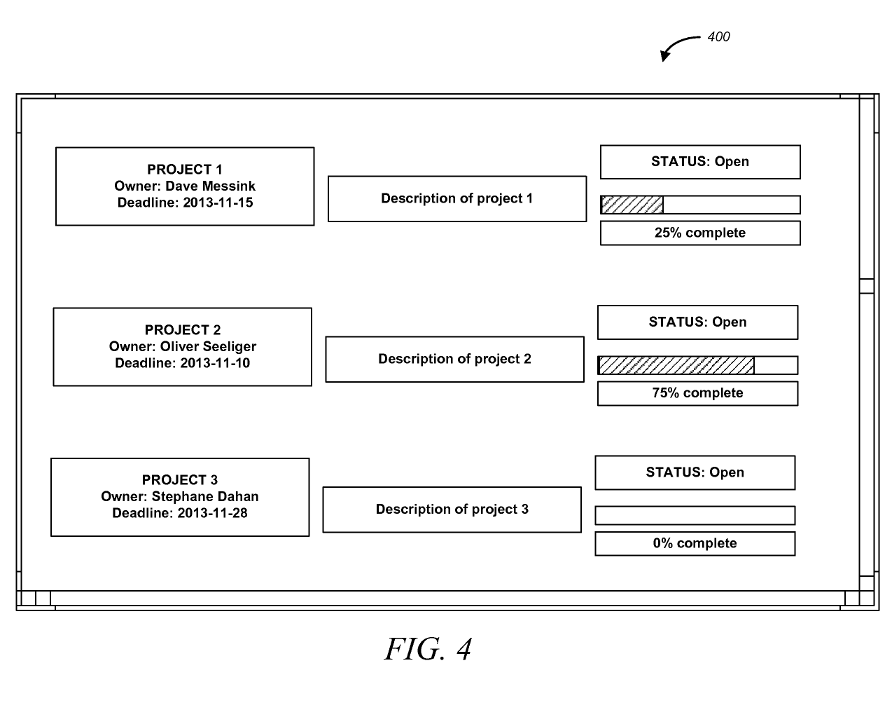

As shown in FIG. 3, the method 300 commences at operation 310, when a request detector 202 of FIG. 2 receives a project management request. The project management request includes an identification of a product change, which is a change to one or more components of a computing application. At operation 320, the dependencies investigator 204 of FIG. 2 determines, based on the identification of the product change, which components of the computing application are affected by the product change. Affected components may be, e.g., services, libraries, documents, etc. As explained above, the dependencies investigator 204 may utilize a dependencies database to make this determination. The collection of all components of the computing application that were determined to have been affected by the product change is referred to as a project. At operation 330, the project progress monitor 206 of FIG. 2 commences monitoring status of each of the one or more components of the project with respect to a testing cycle of the computing application. As explained above, the project progress monitor 206 may obtain the monitored information from the change request tracker 144. The information obtained by the project progress monitor 206 is used by the progress view generator 208 of FIG. 2 to generate one or more project views for presenting information regarding a status of the project with respect to a testing cycle, such as, e.g., a project progress view and a detailed project view. An example project progress view is illustrated in FIG. 4.

FIG. 4 is an example view for presenting information regarding a status of a project associated with the product change. As shown in FIG. 4, the view 400 lists three services and their respective statuses. The test cycle for the first service is shown to be 25% complete, the test cycle for the second service is shown to be 75% complete, and test cycle for the third service is shown to be 0% complete. Based on the view, a developer may be able to project the ETA for the project. The progress value may be calculated based on the total number of services included in the project and the number of services in the project that have completed the testing cycle successfully and have been deployed to production.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

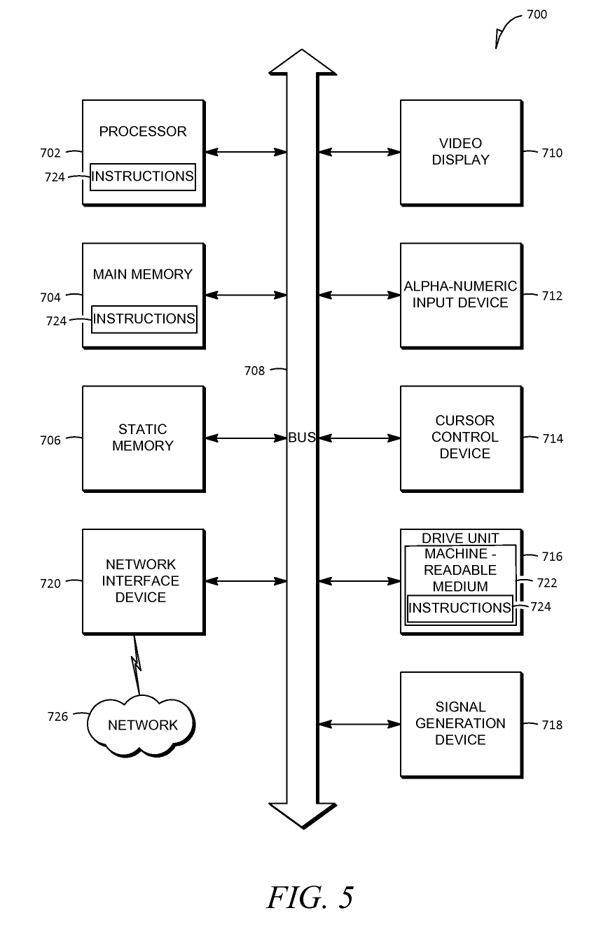

FIG. 5 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a target machine in a server-target network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, target or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a project management tool system has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A method comprising:
receiving a project management request, the project management request comprising an identification of a product change, the product change associated with a computing application, the computing application comprising a plurality of components;
based on the identification of the product change, determining one Or more components from the plurality of components of the computing application that are affected by the product change, the one or more components included in a project, using at least one processor; and
monitoring status of each of the one or more components with respect to a testing cycle of the computing application, wherein the status indicates estimated time of arrival (ETA) of a product that has the product change.

2. The method of claim 1, comprising generating a project view for presenting information regarding a status of the project with respect to the testing cycle.

3. The method of claim 2, wherein the project view is a project progress view to present information regarding a status of the project with respect to the testing cycle.

4. The method of claim 2, wherein the project view is a detailed project view to display respective status information for each of the one or more components in the project with respect to the testing cycle.

5. The method of claim 4, wherein the detailed project view is to display owner information for a component from the one or more components in the project.

6. The method of claim 1, wherein the identification of the product change comprises a name of a service from the computing application and a version of the service.

7. The method of claim 1, wherein the identification of the product change comprises a name of a library from the computing application and a version of the library.

8. The method of claim 1, wherein the identification of the product change comprises a revision number associated with the computing application.

9. The method of claim 1, wherein the determining of the one or more components of the computing application that are affected by the product change comprises interrogating a dependencies database.

10. The method of claim 1, wherein the computing application is an on-line social networking system.

11. A computer implemented system comprising:
a request detector, implemented using at least one processor, to receive a project management request, the project management request comprising an identification of a product change, the product change associated with a computing application, the computing application comprising a plurality of components;
a dependencies investigator, implemented using at least one processor, to determine one or more components from the plurality of components of the computing application that are affected by the product change based on the identification of the product change; and
a project progress monitor, implemented using at least one processor, to monitor status of each of the one or more components in a testing cycle of the computing application, wherein the status indicates estimated time of arrival (ETA) of a product that has the product change.

12. The system of claim 11, comprising a progress view generator to generate, using the at least one processor, a project view for presenting information regarding a status of the project with respect to the testing cycle.

13. The system of claim 12, wherein the project view is a project progress view to present information regarding a status of the project with respect to the testing cycle.

14. The system of claim 12, wherein the project view is a detailed project view to display respective status information for the one or more components in the project with respect to the testing cycle.

15. The system of claim 14, wherein the detailed project view is to display owner information for a component from the one or more components in the project.

16. The system of claim 11, wherein the identification of the product change comprises a name of a service from the computing application and a version of the service.

17. The system of claim 11, wherein the identification of the product change comprises a name of a library from the computing application and a version of the library.

18. The system of claim 11, wherein the identification of the product change comprises a revision number associated with the computing application.

19. The system of claim 11, wherein the dependencies investigator is to interrogate a dependencies database to determine of the one or more components of the computing application that are affected by the product change.

20. A machine-readable non-transitory storage medium having instruction data to cause a machine to perform operations comprising:
receiving a project management request, the project management request comprising an identification of a product change, the product change associated with a computing application, the computing application comprising a plurality of components;
determining one or more components from the plurality of components of the computing application that are affected by the product change based on the identification of the product change; and
monitoring status of each of the one or more components in a testing cycle of the computing application, wherein the status indicates estimated time of arrival (ETA) of a product that has the product change.
